(19) United States
(12) Patent Application Publication
(10) Pub. No.: US 2020/0342843 A1
(43) Pub. Date: Oct. 29, 2020

(54) METHOD FOR MANUFACTURING AN ACOUSTIC ABSORPTION STRUCTURE USING AT LEAST ONE CAUL PLATE, ACOUSTIC ABSORPTION STRUCTURE OBTAINED FROM SAID METHOD AND AIRCRAFT COMPRISING SAID ACOUSTIC ABSORPTION STRUCTURE

(71) Applicant: Airbus Operations SAS, Toulouse (FR)

(72) Inventors: Denis BROSSARD, TOULOUSE (FR); Florian RAVISE, TOULOUSE (FR)

(21) Appl. No.: 16/859,138

(22) Filed: Apr. 27, 2020

(30) Foreign Application Priority Data
Apr. 29, 2019 (FR) 1904497

(51) Int. Cl. G10K 11/168; F02K 1/34; B64D 27/18

(52) U.S. Cl. CPC G10K 11/168; B64D 27/18; B64D 33/06

(57) ABSTRACT

A method for manufacturing an acoustic absorption structure including an acoustically resistive layer, a cellular structure, a reflective layer and a plurality of acoustic elements positioned in cavities produced in the cellular structure. This method comprises steps of depositing fiber plies on a contact surface of the cellular structure, fitting a flexible jacket which covers a stack composed of the acoustically resistive layer, the cellular structure and the fiber plies, which is tightly linked with the deposition surface all around the stack, consolidating the fiber plies to form the reflective layer and the fixing thereof on the cellular structure, with a caul plate being inserted between the fiber plies and the flexible jacket during the consolidation step.

### CROSS-REFERENCES TO RELATED APPLICATIONS

This application claims the benefit of the French patent application No. 1904497 filed on Apr. 29, 2019, the entire disclosures of which are incorporated herein by way of reference.

### FIELD OF THE INVENTION

The present application relates to a method for manufacturing an acoustic absorption structure using at least one caul plate, to an acoustic absorption structure obtained from the method and to an aircraft comprising the acoustic absorption structure.

### BACKGROUND OF THE INVENTION

According to an embodiment of the prior art, a propulsive assembly comprises a nacelle and a turbofan engine, positioned inside the nacelle. Some surfaces of the nacelle and of the turbofan engine comprise acoustic absorption structures for attenuating the noise nuisances. According to one embodiment, an acoustic absorption structure comprises an acoustically resistive layer, a honeycomb cellular layer and a reflective layer.

An ultrahigh bypass ratio UHBR turbofan engine has a fan rotating at lower frequencies than some turbofan engines currently on the market so that the acoustic absorption structures have to be configured to attenuate low frequency sound waves. To attenuate such sound waves, the honeycomb cellular layer must have a significant height, which is detrimental in weight, bulk and manufacturing terms.

An acoustic absorption structure that makes it possible to absorb low frequency sound waves is described in the document “aero-acoustic liner applications of the broadband special acoustic absorber concept, American Institute of Aeronautics and Astronautics, AIAA 2013-2176, 19th AIAA/CEAS Aeroacoustics Conference May 27-29, 2013, Berlin, Germany.” According to an embodiment that can be seen in FIGS. 1 and 2, an acoustic absorption structure 10 comprises an acoustically resistive layer 12 in contact with a medium in which sound waves are propagated, a cellular structure 14, a reflective layer 16 and a plurality of acoustic elements 18 positioned in the cellular structure 14. Each of them comprises a capsule 20 closed by the acoustically resistive layer 12 so as to delimit a cavity 22 in which a hollow cone 24 is positioned, away from the capsule 20, which has an aperture 26 emerging at the acoustically resistive layer 12. Each cone 24 comprises at least one acoustic orifice 28, allowing the interior of the cone 24 to communicate with the space between the cone 24 and the capsule 20, positioned and dimensioned according to the acoustic characteristics sought.

An acoustic absorption structure 10 formed in this way, based on the same principle as a Helmholtz resonator and a quarter-wave resonator, makes it possible to effectively attenuate the low frequency sounds emitted by a turbofan engine of UHBR type.

According to one embodiment, the acoustic elements 18 are produced, independently of one another, by molding or by injection, with resin filled with short fibers or without fibers.

In parallel, according to a first variant, the cellular structure 14, not yet formed, is machined so as to produce a cavity 30 for each acoustic element 18, as illustrated in FIG. 3. After the production of the cavities 30, the cellular structure 14 is formed and maintained in a deformed position by virtue of at least one holding ply 32 glued against the face of the cellular structure 14 oriented toward the reflective layer 16 once the acoustic absorption structure is produced, as illustrated in FIG. 4.

The acoustic elements 18 are glued and positioned in the cavities 30, as illustrated in FIG. 5. Next, the cellular structure 14 comprising the acoustic elements 18 is turned over and pressed against the acoustically resistive layer 12, as illustrated in FIG. 6. Fiber plies 34 are then deposited on the holding ply 32 to form the reflective layer 16, as illustrated in FIG. 7. Finally, this assembly is subjected to a consolidation (or polymerization) step so as to obtain an acoustic absorption structure 10, as illustrated in FIG. 8. During this step, the acoustic elements 18 have a tendency to move downward and to come into contact with the acoustically resistive layer 12, which creates a marking 36 thereof, a deformation of the cellular structure 14 in line with the acoustic elements 18 and cup-shaped surface defects 38 on the reflective layer 16.

The present invention aims to remedy all or some of the drawbacks of the prior art.

### SUMMARY OF THE INVENTION

To this end, a subject of the invention is a method for manufacturing an acoustic absorption structure comprising an acoustically resistive layer, a reflective layer, a cellular structure having first and second contact surfaces, respectively, in contact with the acoustically resistive layer and the reflective layer once assembled, and a plurality of acoustic elements positioned in cavities produced in the cellular structure and emerging at the first contact surface. The method comprises steps:

of production of the cavities,

of fitting and of fixing of the acoustic elements in their cavities,

of deposition of the acoustically resistive layer on a deposition surface,

of deposition of the cellular structure on the acoustically resistive layer,

of deposition of fiber plies on the second contact surface of the cellular structure,

of fitting of a flexible jacket which covers a stack composed of the acoustically resistive layer, of the cellular structure and of the fiber plies and which is tightly linked with the deposition surface all around the stack, and

consolidation of the fiber plies to form the reflective layer and secure it to the cellular structure.

According to the invention, a caul plate is inserted between the fiber plies and the flexible jacket during the consolidation step.

During consolidation, the caul plate limits the subsidence of the cellular structure in line with the acoustic elements so that the reflective layer has an enhanced surface condition without cup-shaped surface defects as in the case of the prior art.

Furthermore, the caul plate makes it possible to prevent the flexible jacket from pushing parts of the cellular structure toward the acoustic elements, provoking a movement thereof toward the acoustically resistive layer and the marking thereof.

According to another feature, a mold-stripping film is inserted between the fiber plies and the caul plate.

According to another feature, the method comprises a step of deformation of the cellular structure comprising:

pressing the first contact surface of the cellular structure against a conformation surface which has a geometry identical to a geometry desired for the cellular structure,

positioning at least one holding ply on the second contact surface of the cellular structure,

fitting a flexible jacket which covers the cellular structure and which is tightly linked to the conformation surface all around the cellular structure,

consolidating and fixing the holding ply or plies on the second contact surface of the cellular structure in the deformed state, a caul plate being inserted between the holding ply or plies and the flexible jacket during consolidation.

According to another feature, a mold-stripping film is inserted between the holding ply or plies and the caul plate.

Another subject of the invention is an acoustic absorption structure obtained from the manufacturing method previously described and an aircraft comprising at least one such acoustic absorption structure.

### BRIEF DESCRIPTION OF THE DRAWINGS

Other features and advantages will emerge from the following description of the invention, the description being given purely by way of example, in light of the attached drawings in which:

FIG. 1 is a perspective view of an acoustic absorption structure which illustrates an embodiment of the prior art,

FIG. 2 is a perspective view of the acoustic absorption structure that can be seen in FIG. 1 during assembly,

FIG. 3 is a transverse cross-section of a cellular structure after a step of production of cavities which illustrates an embodiment of the prior art,

FIG. 4 is a transverse cross-section of the cellular structure that can be seen in FIG. 3 after a deformation step which illustrates an embodiment of the prior art,

FIG. 5 is a transverse cross-section of the cellular structure that can be seen in FIG. 4 during a step of placement of acoustic elements which illustrates an embodiment of the prior art,

FIG. 6 is a transverse cross-section of the cellular structure that can be seen in FIG. 5 during a step of deposition on an acoustically resistive layer which illustrates an embodiment of the prior art,

FIG. 7 is a transverse cross-section of the cellular structure that can be seen in FIG. 6 after a step of deposition of fiber plies of a reflective layer which illustrates an embodiment of the prior art,

FIG. 8 is a transverse cross-section of an acoustic absorption structure which illustrates an embodiment of the prior art,

FIG. 9 is a side view of an aircraft,

FIG. 10 is a longitudinal cross-section of a part of a duct of a propulsive assembly of an aircraft,

FIG. 11 is a transverse cross-section of a cellular structure after a step of production of cavities which illustrates an embodiment of the invention,

FIG. 12 is a transverse cross-section of the cellular structure that can be seen in FIG. 11 during a deformation step which illustrates an embodiment of the invention,

FIG. 13 is a transverse cross-section of the cellular structure that can be seen in FIG. 12 during a step of fitting of acoustic elements which illustrates an embodiment of the invention,

FIG. 14 is a transverse cross-section of the cellular structure than can be seen in FIG. 13 during a step of deposition on an acoustically resistive layer which illustrates an embodiment of the invention,

FIG. 15 is a transverse cross-section of the cellular structure that can be seen FIG. 14 after a step of deposition of fiber plies of a reflective layer which illustrates an embodiment of the invention, and

FIG. 16 is a transverse cross-section of an acoustic absorption structure which illustrates an embodiment of the invention.

### DETAILED DESCRIPTION OF THE PREFERRED EMBODIMENTS

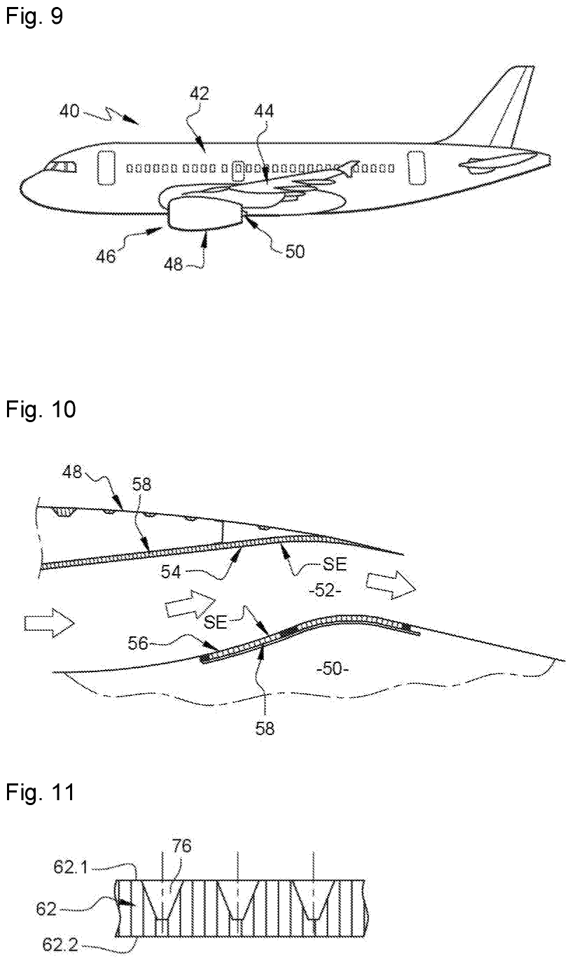

FIG. 9 shows an aircraft 40 which has a fuselage 42, two wings 44, disposed on either side of the fuselage 42, and propulsive assemblies 46 fixed under the wings 44. Each propulsive assembly 46 comprises a nacelle 48 and a turbofan engine 50 positioned inside the nacelle 48.

According to an embodiment illustrated in FIG. 10, each propulsive assembly 46 comprises an ejection duct 52 delimited by an outer wall 54, secured to the nacelle 48, and by an inner wall 56 secured to the turbofan engine 50.

According to one configuration, each inner or outer wall 54, 56 comprises at least one acoustic absorption structure 58 which has an outer surface SE in contact with a medium in which sound waves are propagated.

Although described as applied to an ejection duct 52, the invention is not limited to that application. Thus, the acoustic absorption structure 58 can be positioned on any wall of the aircraft which has an outer surface in contact with a medium in which sound waves are propagated.

According to an embodiment that can be seen in FIG. 16, the acoustic absorption structure 58 comprises an acoustically resistive layer 60, having an outer face 60.1, forming the outer surface SE of the acoustic absorption structure 58, an inner face 60.2 opposite the outer face 60.1, a cellular structure 62, a reflective layer 64 and a plurality of acoustic elements 66 positioned in the cellular structure 62 against the inner face 60.2 of the acoustically resistive layer 60.

According to one embodiment, the cellular structure 62 is of honeycomb type and comprises a plurality of through-cells 68, juxtaposed and having a given section. According to an embodiment that can be seen in FIG. 16, the acoustically resistive layer 60 comprises at least one sheet which is porous, at least in line with the acoustic elements 66. Obviously, the invention is not limited to this embodiment. Thus, the acoustically resistive layer 60 could be porous over all of its surface.

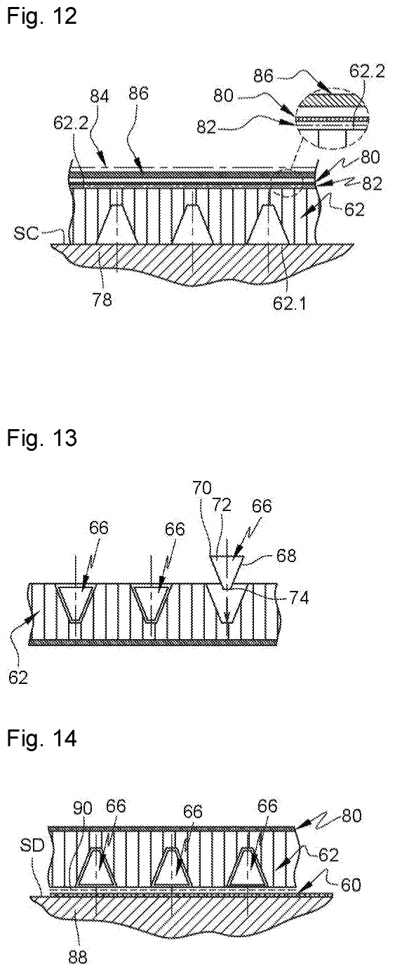

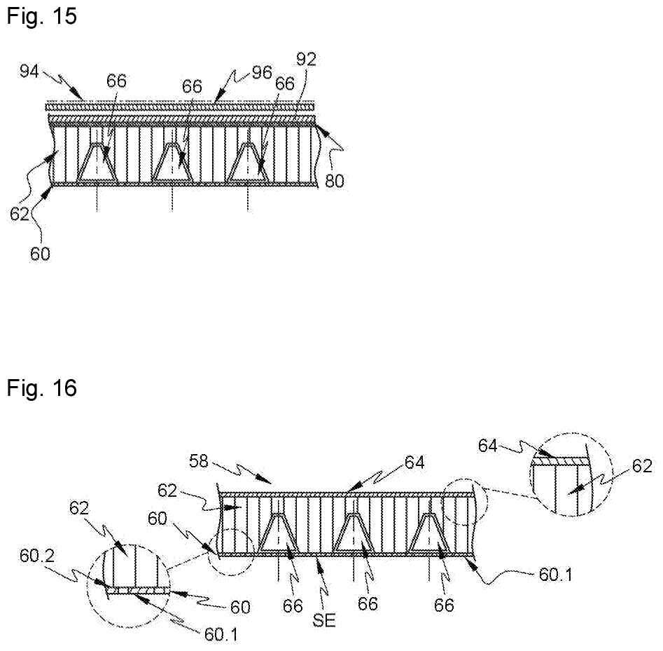

According to an embodiment that can be seen in FIG. 13, each acoustic element 66 comprises an enclosure 68, also called capsule, which has a mouthpiece 70 delimited by an edge pressed against the inner face 60.2 of the acoustically resistive layer 60 so that the enclosure 68 and the acoustically resistive layer 60 delimit a cavity 72, an acoustic orifice 74 passing through the enclosure 68 to connect the cavity 72 with at least one cell 68 of the cellular structure 62. Each enclosure 68 can be tapered, in the form of a truncated pyramid or have any other form.

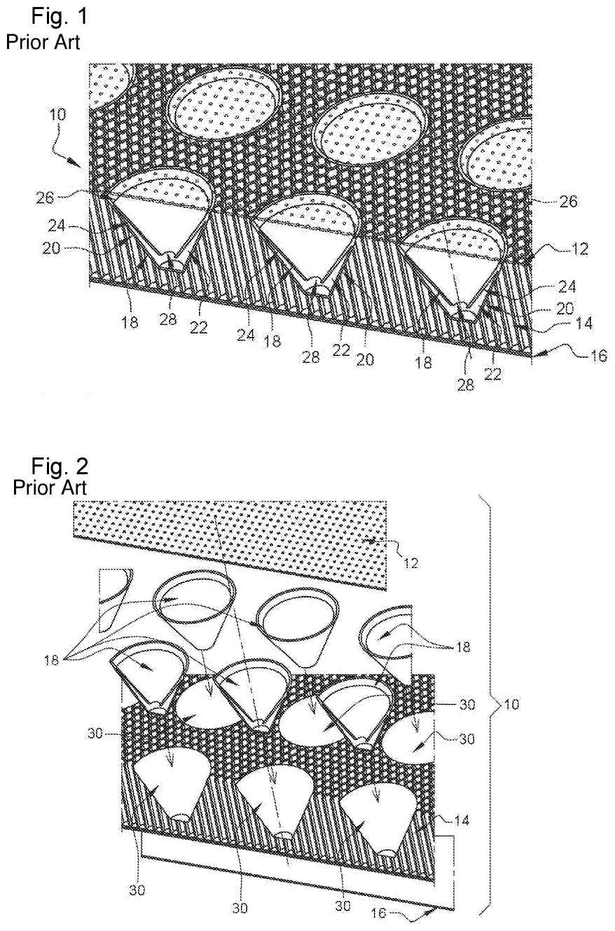

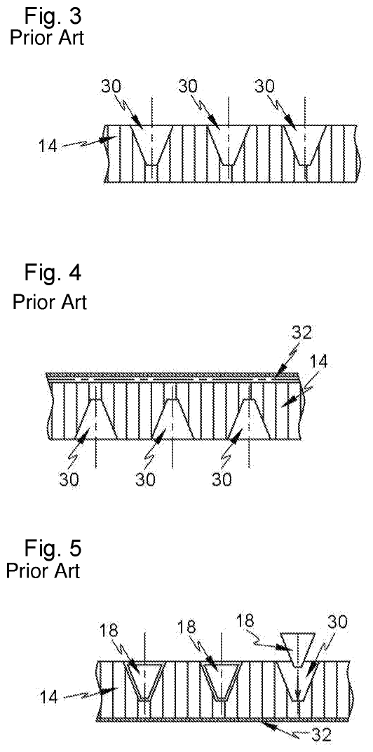

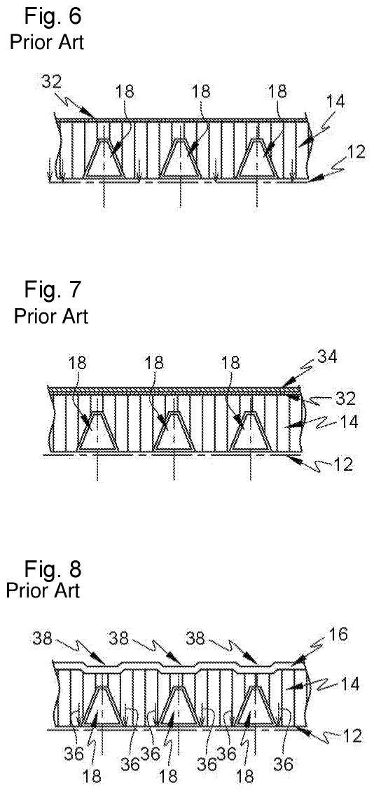

According to another embodiment, the acoustic elements 66 are identical to those of the prior art that can be seen in FIGS. 1 and 2. Thus, each acoustic element 66 comprises a capsule closed by the acoustically resistive layer 60 so as to delimit a first cavity in which a hollow cone is positioned, away from the capsule, which has an aperture emerging at the acoustically resistive layer 60. Each cone comprises at least one acoustic orifice, making it possible to connect the interior of the cone with the space between the cone and the capsule, positioned and dimensioned according to the acoustic characteristics sought.

According to one arrangement, the acoustic elements 66 are arranged in several rows and several columns. Obviously, the invention is not limited to this arrangement for the acoustic elements 66 and/or to these embodiments.

The cellular structure 62, the acoustic elements 66, the acoustically resistive layer 60, the reflective layer 64 can be metal or made of composite material.

The cellular structure 62 has first and second contact surfaces 62.1, 62.2, against which are added respectively the acoustically resistive layer 60 and the reflective layer 64, which are initially parallel and planar.

According to a first embodiment, the method for producing the acoustic absorption structure comprises a first step of production of cavities 76 in the cellular structure 62 from the first contact surface 62.1, as illustrated in FIG. 11. According to a first procedure, the cavities 76 are produced by machining the cellular structure 62. Each cavity 76 is configured to receive, without play, an acoustic element 66 in such a way that the latter is flush with the first contact surface 62.1. This step of production of the cavities 76 is not detailed further because it can be identical to that of the prior art.

The method for producing the acoustic absorption structure comprises a second step of deformation of the cellular structure 62 according to a desired geometry and of holding of the cellular structure 62 according to this desired geometry, as illustrated in FIG. 12. To this end, the first contact surface 62.1 of the cellular structure 62 is pressed against a conformation surface SC of a mold 78 which has a geometry identical to the geometry desired for the cellular structure 62. For the purposes of simplification, the conformation surface SC is represented as planar. In reality, this conformation surface SC is generally curved. At least one holding ply 80 is deposited and fixed on the second surface 62.2 of the cellular structure in the deformed state. According to one configuration, a film of glue 82 is inserted between the holding ply 80 and the second contact surface 62.2 of the cellular structure. According to one embodiment, the holding ply 80 is a ply of fibers that are pre-impregnated or not.

According to one procedure, the cellular structure 62 is pressed against the conformation surface SC. The film of glue 82, then the holding ply 80, are positioned on the second contact surface 62.2 of the cellular structure 62. Next, a flexible jacket 84 (generally called bladder) is positioned so as to cover the cellular structure 62 and to be linked, tightly, with the conformation surface SC all around the cellular structure 62. Next, the assembly formed by the cellular structure 62, the film of glue 82 and the holding ply 80 is subjected to a temperature and pressure rise so as to obtain a consolidation of the holding ply or plies 80 and a fixing of the holding ply or plies 80 on the second contact surface 62.2 of the cellular structure 62 in the deformed state.

Consolidation is understood to mean both consolidation and polymerization.

According to a feature of the invention, a caul plate 86 is inserted between the holding ply or plies 80 and the flexible jacket 84 during consolidation in order to distribute the pressure forces uniformly over all the surface area of the second contact surfaces 62.2 of the cellular structure 62 and to limit the risks of deformation of the cellular structure 62 in line with the cavities 76.

To facilitate the removal of the caul plate 86 after the fixing of the holding ply or plies 80 on the second contact surface 62.2, a mold-stripping film is inserted between the holding ply or plies 80 and the caul plate 86.

According to a second embodiment, the first and second steps are reversed. Thus, the cellular structure 62 is first of all deformed and held in the deformed position by at least one holding ply 80, then the cavities 76 are produced in the cellular structure 62 that is already deformed. According to this second embodiment, the use of a caul plate 86 is not necessary.

The method for producing the acoustic absorption structure comprises a step of fitting, and of fixing, of the acoustic elements 66 in their cavities 76, as illustrated in FIG. 13. According to one configuration, the acoustic elements 66 are glued, then inserted in the cavities 76. This step of fitting and of fixing of the acoustic elements 66 is not detailed further because it can be identical to that of the prior art.

The method for producing the acoustic absorption structure comprises a step of deposition of the cellular structure 62 comprising acoustic elements 66 on the acoustically resistive layer 60, as illustrated in FIG. 14. To this end, the acoustically resistive layer 60 is positioned on a deposition surface SD of a mold 88 conformed as the cellular structure 62, then the first contact surface 62.1 of the cellular structure 62 is positioned against the acoustically resistive layer 60 in order to secure them.

For the purposes of simplification, the deposition surface SD is represented as planar. In reality, this deposition surface SD is generally curved.

According to one procedure, a film of glue 90 is inserted between the acoustically resistive layer 60 and the cellular structure 62. This film of glue 90 can be activated after this step of deposition of the cellular structure 62 equipped with the acoustic elements 66 on the acoustically resistive layer 60 or at the same time as the consolidation of the reflective layer 64, as indicated later.

This step of deposition of the cellular structure 62 equipped with the acoustic elements 66 on the acoustically resistive layer 60 is not described further because it can be identical to that of the prior art.

The method for producing the acoustic absorption structure comprises a step of deposition of fiber plies 92 on the second contact surface 62.2 of the cellular structure 62 (more particularly on the holding ply or plies 80) and of consolidation of the fiber plies 92 to form the reflective layer 64 and of securing thereof. At least one film of glue can be deposited under and/or between the fiber plies 92.

Next, a flexible jacket 94 (also called bladder) is positioned so as to cover a stack composed of the acoustically resistive layer 60, the cellular structure 62 and the fiber plies 92 then to be linked tightly with the deposition surface SD all around the stack. Next, the assembly formed by the cellular structure 62, the fiber plies 92 and the possible films of glue is subjected to a temperature and pressure rise so as to obtain the consolidation of the reflective layer 64 and the fixing thereof on the second contact surface 62.2 of the cellular structure 62. According to one procedure, the securing of the acoustically resistive layer 60 and of the reflective layer 64 on the cellular structure 62 can be performed during one and the same consolidation step.

According to a feature of the invention, a caul plate 96 is inserted between the fiber plies 92 and the flexible jacket 94, during the consolidation step, in order to distribute the pressure forces uniformly over all the surface area of the second contact surface 62.2 of the cellular structure 62 and limit the risks of deformation of the cellular structure 62 in line with the cavities 76.

To facilitate the removal of the caul plate 96 after the consolidation of the reflective layer 64, a mold-stripping film is inserted between the fiber plies 92 and the caul plate 96.

Contrary to the prior art, the caul plate 96 makes it possible to prevent the flexible jacket 94 from pushing parts of the cellular structure 62 toward the acoustic elements 66 causing a movement thereof toward the acoustically resistive layer 60 and the marking thereof.

Furthermore, with the caul plate 96 limiting the subsidence of the cellular structure 62 in line with the acoustic elements 66, the reflective layer 64 has an enhanced surface condition, without cup-shaped surface defects as in the case of the prior art.

According to one embodiment, each caul plate 86, 96 is metal made, for example, of stainless steel, titanium or aluminum alloy.

According to another embodiment, each caul plate 86, 96 is made of composite material and comprises fibers embedded in a thermosetting or thermoplastic resin matrix.

The material and thickness of each caul plate 86, 96 are determined in such a way that the caul plate 86, 96 cannot be deformed in the manner of a flexible jacket. However, the caul plate 86, 96 can be sufficiently flexible to follow the curvature of the cellular structure 62.

Each caul plate 86, 96 is dimensioned so as to cover all the surface area of the cellular structure 62. Each caul plate 86, 96 can be produced in a single piece or in several juxtaposed parts.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing an acoustic absorption structure comprising an acoustically resistive layer, a reflective layer, a cellular structure having first and second contact surfaces respectively in contact with the acoustically resistive layer and the reflective layer once assembled, and a plurality of acoustic elements positioned in cavities produced in the cellular structure and emerging at the first contact surface, said method comprising:
producing the cavities,
fitting and fixing the acoustic elements in the cavities,
depositing the acoustically resistive layer on a deposition surface,
depositing the cellular structure on the acoustically resistive layer,
depositing fiber plies on the second contact surface of the cellular structure,
fitting of a flexible jacket which covers a stack composed of the acoustically resistive layer, the cellular structure and the fiber plies, and which is tightly linked with the deposition surface all around the stack, and
consolidating the fiber plies to form the reflective layer and securing the reflective layer to the cellular structure,
wherein a caul plate is inserted between the fiber plies and the flexible jacket during the consolidation step.

2. The manufacturing method as claimed in claim 1, wherein a mold-stripping film is inserted between the fiber plies and the caul plate.

3. The method for manufacturing an acoustic absorption structure as claimed in claim 1, wherein the method comprises a step of deforming the cellular structure comprising:
pressing the first contact surface of the cellular structure against a conformation surface which has a geometry identical to a geometry desired for the cellular structure to achieve a deformed state for the cellular structure,
positioning at least one holding ply on the second contact surface of the cellular structure,
fitting a flexible jacket which covers the cellular structure and which is tightly linked with the conformation surface all around the cellular structure, and
consolidating and fixing the holding ply or plies on the second contact surface of the cellular structure in the deformed state, a caul plate being inserted between the holding ply or plies and the flexible jacket during consolidation.

4. The manufacturing method as claimed in claim 3, wherein a mold-stripping film is inserted between the holding ply or plies and the caul plate.

5. An acoustic absorption structure obtained from a manufacturing method as claimed in claim 1.

6. An aircraft comprising at least one acoustic absorption structure as claimed in claim 5.
